(19) United States
(12) Patent Application Publication
(10) Pub. No.: US 2018/0096263 A1
(43) Pub. Date: Apr. 5, 2018

(54) SYSTEM AND METHOD FOR REAL TIME, GEOLOCATION BASED PARKING DATA ANALYSIS

(71) Applicant: MasterCard International Incorporated, Purchase, NY (US)

(72) Inventors: Rohit MODI, New Delhi (IN); Ashutosh GUPTA, Varanasi Uttar Pradesh (IN); Ankur ARORA, New Delhi (IN); Rachit VERMA, New Delhi (IN)

(73) Assignee: MasterCard International Incorporated, Purchase, NY (US)

(21) Appl. No.: 15/284,994

(22) Filed: Oct. 4, 2016

(51) Int. Cl. G06Q 10/02; G07B 15/00

(52) U.S. Cl. CPC G06Q 10/02; G07B 15/00

(57) ABSTRACT

A method for real time, geolocation based parking data analysis is described. The method includes providing a list of available parking spaces to a user device for a user to select and calculating the parking fee based at least on a duration that a vehicle stayed in a predetermined area that encompasses the selected parking space and the geographic position of the selected parking space.

### FIELD

The present disclosure relates to a method and system for real time, geolocation based parking data analysis.

### BACKGROUND

In dense cities like New York City, Washington, D.C., and Chicago and locations where a significant amount of people may visit, such as large shopping malls, arenas, stadiums, and concert venues, the amount of available parking may be extremely limited. Although designated parking structures or areas may be available in a given area to increase the available parking, these structures or areas will typically require the payment of a fee to recoup operating costs, limit demand, and limit both the number of parked cars and the duration cars occupy a given parking space. Further, the presence of additional parking structures or areas may be insufficient to satisfy the demand for parking, particularly when a special event is being held in the area.

More particularly, when seeking a parking space, individuals normally do not have information regarding the amount of available parking, the current demand for parking, or the price that may be charged at a particular parking structure or area. Instead, individuals rely on luck or past experience to dictate whether or not they consider the price for a particular parking space to be acceptable. This may result in the individual overpaying for a parking space or inconveniencing himself or herself while seeking a more acceptable parking space. Similarly, the owners of parking structures or areas set the price for a parking space based on past experience, but also do not have information regarding the available parking in the area, the current demand for parking, or the price being charged by competitors in the vicinity. This may result the prices for parking spaces being less than what individuals may be willing to pay, which reduces the revenue collected by the owner. Thus, a mismatch between the supply and demand of parking exists, which may result in less than optimal outcomes for both the individuals seeking a parking space and the owners of the parking structures or areas.

In an effort to reduce this discrepancy between the price and the demand for parking in a given parking structure or area, those with parking spaces have employed methods for determining how many spaces are available within the structure have been occupied. One technique relies on sensors to determine if each parking space is occupied. Another technique counts the number of vehicles that have entered and exited the parking structure. Individuals seeking a parking space often times only have this information for the parking structure or area they are attempting to enter, often displayed as the individual enters the parking structure or area, but not for nearby parking structures or areas. In addition, the owner of the parking structure or area typically cannot adjust pricing to reflect the relative occupancy and amenities of their parking structure or area.

Thus, there is a need for a technical solution for individuals to locate available parking spaces more efficiently than the current approach, and for owners to improve the revenue realized from their parking structure or area.

### SUMMARY

The present disclosure provides a description of systems and methods for real time, geolocation based parking data analysis.

For example, a method for real time, geolocation based parking data analysis, may include: storing parking space information in a parking space database, wherein the parking space information includes a plurality of parking space identifiers corresponding to a plurality of parking spaces and a geographic position of each of the plurality of parking spaces; receiving, from a user device, an indication of a selected parking space among the plurality of the parking spaces; calculating an amount of a parking fee for a vehicle associated with the user device in accordance with a pricing algorithm based at least on a duration that the vehicle stayed in a predetermined area that encompasses the selected parking space and the geographic position of the selected parking space in response to a determination that the vehicle is leaving the predetermined area; transmitting the calculated amount of the parking fee to the user device; and receiving a payment request for a payment of the parking fee from the user device

Another example method for real time, geolocation based parking data analysis, may include receiving a list of available parking spaces and a geographic position associated with each of the available parking spaces from a processing server; displaying the list of available parking spaces and associated geographic positions on a display of a user device; receiving a user input that indicates a selection of one of the available parking spaces; transmitting the selection of one of the available parking spaces to the processing server; receiving an amount of a parking fee from the processing server upon a vehicle leaving a predetermined area that encompasses the available parking spaces, wherein the amount of the parking fee is calculated in accordance with a pricing algorithm based at least on a duration that the vehicle stayed in the predetermined area and the geographic position of the selected parking space; providing payment information for a payment of the parking fee, wherein the payment information includes an account identifier of an account and validation information associated with the account; and receiving an indication that the payment of the parking fee is made.

Further, the method may be embodied in a system for real time, geolocation based parking data analysis, comprising: a storage unit configured to store parking space information in a parking space database, wherein the parking space information includes a plurality of parking space identifiers corresponding to a plurality of parking spaces and a geographic position of each of the plurality of parking spaces; a receiver configured to receive, from a user device, an indication of a selected parking space among the plurality of the plurality of the parking spaces; a parking fee calculator configured to calculate an amount of a parking fee for a vehicle associated with the user device in accordance with a pricing algorithm based at least on a duration that the vehicle stayed in a predetermined area that encompasses the selected parking space and the geographic position of the selected parking space in response to a determination that the vehicle is leaving the predetermined area; and a transmitter configured to transmit the calculated amount of the parking fee to the user device.

Further still, the other method may be embodied in a system for real time, geolocation based parking data analysis, comprising a receiver configured to receive a list of available parking spaces and a geographic position associated with each of the available parking spaces from a processing server; a display configured to display the list of available parking spaces and associated geographic positions on a display of a user device, wherein the receiver is further configured to receive a user input that indicates a selection of one of the available parking spaces; a transmitter configured to transmit the selection of one of the available parking spaces to the processing server, wherein the receiver is further configured to receive an amount of a parking fee from the processing server upon a vehicle leaving a predetermined area that encompasses the available parking spaces, wherein the amount of the parking fee is calculated in accordance with a pricing algorithm based at least on a duration that the vehicle stayed in the predetermined area and the geographic position of the selected parking space; and a payment controller configured to provide payment information for a payment of the parking fee, wherein the payment information includes an account identifier of an account and validation information associated with the account, wherein the receiver is further configured to receive an indication that the payment of the parking fee is made.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1A is a block diagram illustrating a high level system architecture for real time, geolocation based parking data analysis in accordance with exemplary embodiments.

FIG. 1B is a block diagram illustrating another high level system architecture for real time, geolocation based parking data analysis in accordance with exemplary embodiments.

FIG. 2A is a block diagram illustrating a processing server of FIG. 1 for real time, geolocation based parking data analysis in accordance with exemplary embodiments.

FIG. 2B is a block diagram illustrating a user device of FIG. 1 for real time, geolocation based parking data analysis in accordance with exemplary embodiments.

FIG. 3 is a flow diagram illustrating the interactions between the processing server and the user device of FIG. 1 for real time, geolocation based parking data analysis in accordance with exemplary embodiments.

FIG. 4 is a flow diagram illustrating the process of real time, geolocation based parking data analysis in accordance with exemplary embodiments.

FIG. 5 is another flow diagram illustrating the process of real time, geolocation based parking data analysis in accordance with exemplary embodiments.

FIG. 6 is a flow diagram illustrating the processing of a payment transaction in accordance with exemplary embodiments.

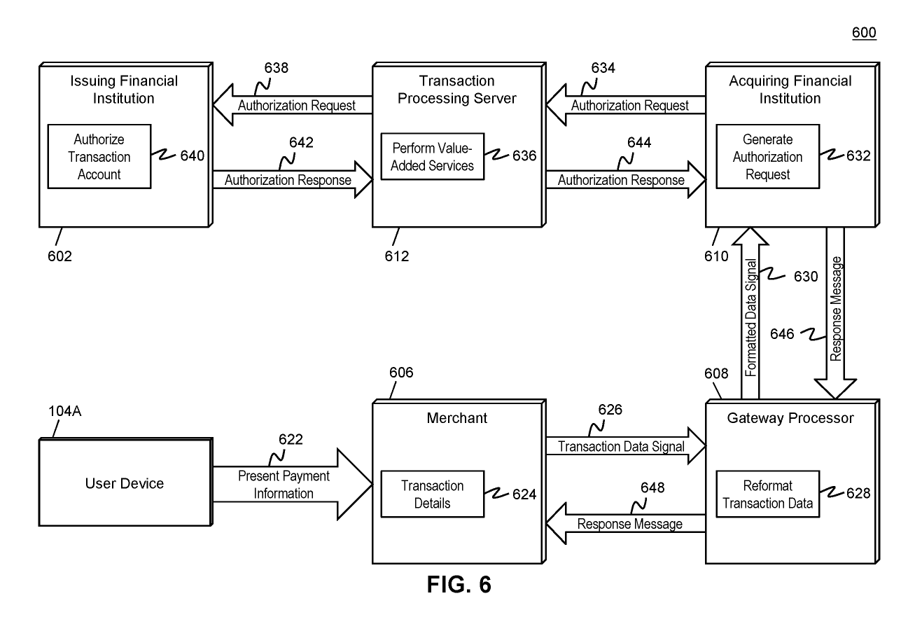

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards (e.g., credit cards, pre-paid cards, debit cards, merchant cards, chip and pin cards, payment credentials on mobile devices that may employ near-field communication (NFC), physical and virtual cards, etc.), letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have and require special knowledge in offered products. In some embodiments, an entity involved in a single transaction may be considered a merchant. In some instances, as used herein, the term “merchant” may refer to an apparatus or device of a merchant entity.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Real Time, Geolocation Based Parking Data Analysis

The system for real-time geolocation based parking data analysis addresses the above described problems for both owners and operators of parking structures and areas along with individuals seeking parking spaces.

### Parking Structures and Areas Comprising Parking Spaces

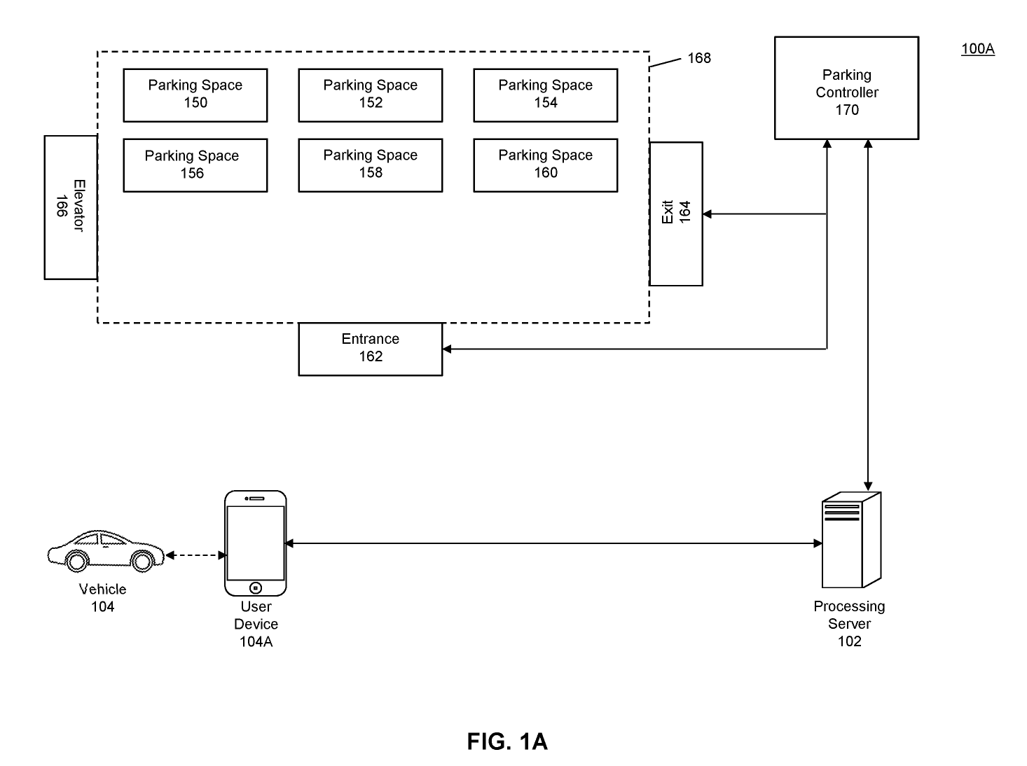

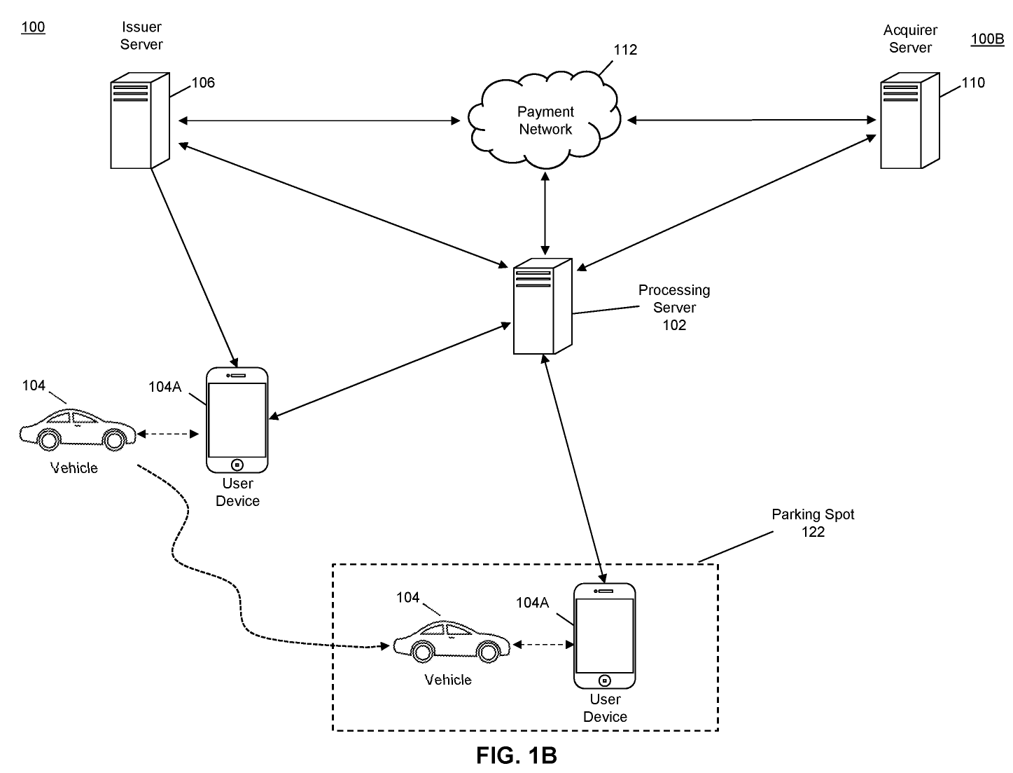

To properly consume parking data for a variety of parking structures or areas, certain common characteristics of such structures and areas must be defined. Parking structures or areas include, and are not limited to, outdoor and indoor parking lots, above ground and below ground parking garages, street parking locations, and temporary parking lots created for special events. Parking structures or areas have at least one parking level 168 which include at least one parking space 150, 152, 154, 156, 158, 160, an entrance 162, and an exit 164. An example of one such parking level 168 is shown in FIG. 1A. Each parking structure or area may include multiple parking levels 168. Some parking levels 168 include features such as elevator 166, stairs, ramps, or other structures for traveling between levels of the parking structure or area. Although depicted as an area with parking spaces 150, 152, 154, 156, 158, 160 arranged in a grid-like fashion in FIG. 1A, parking levels 168 may include parking spaces 150, 152, 154, 156, 158, 160 arranged linearly, in a grid, or in any other suitable fashion.

For each of the parking structures or areas including at least one parking level 168 to be considered by the system described here, certain information is required, such as the geographic position of the parking structure or area and the geographic position of each of the parking spaces 150, 152, 154, 156, 158, 160 contained in the parking structure or area. The geographic information for the parking structure or area may include a mailing address, a street address, or at least one coordinate, such as represented by latitude and/or longitude. Geographic information for the individual parking spaces 150, 152, 154, 156, 158, 160 may not correspond to a mailing address or a street address, and therefore may more commonly be stored as a latitude or longitude. Certain parking spaces 150, 152, 154, 156, 158, 160 may not, however, be easily located using such coordinates because the parking spaces 150, 152, 154, 156, 158, 160 may be underground or otherwise in an area where latitude and longitude would be difficult to derive. In such circumstances, other types of geographic identifiers may be used such as a grid identifier or a sequential identifier. Regardless of the geographic identifier being used, each parking space 150, 152, 154, 156, 158, 160 has a geographic position by which it may be determined if a vehicle has entered or exited the parking space 150, 152, 154, 156, 158, 160. The geographic position also includes, if appropriate for the particular parking level 168, an indicator as to which level the parking space 150, 152, 154, 156, 158, 160 exists in the parking structure or area. Similar to the geographic position associated with each parking space 150, 152, 154, 156, 158, 160, features such as the entrance 162, exit 164, and elevator 166 also have a geographic position. In some embodiments, information such as the geographic position of merchants or other attractions desirable to individuals seeking parking in the parking structure or area may also be included.

### The Processing Server and Parking Controller

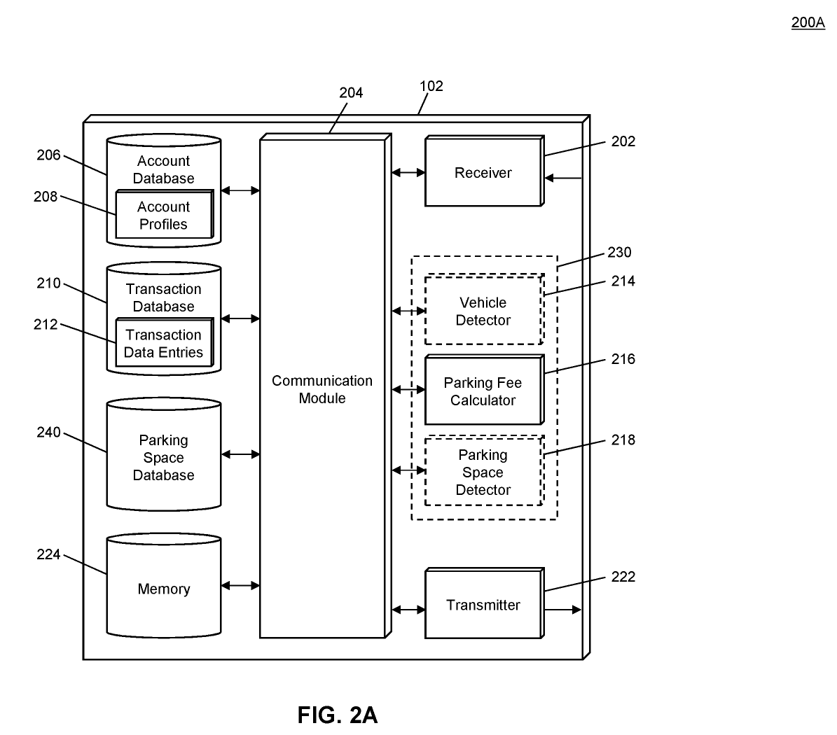

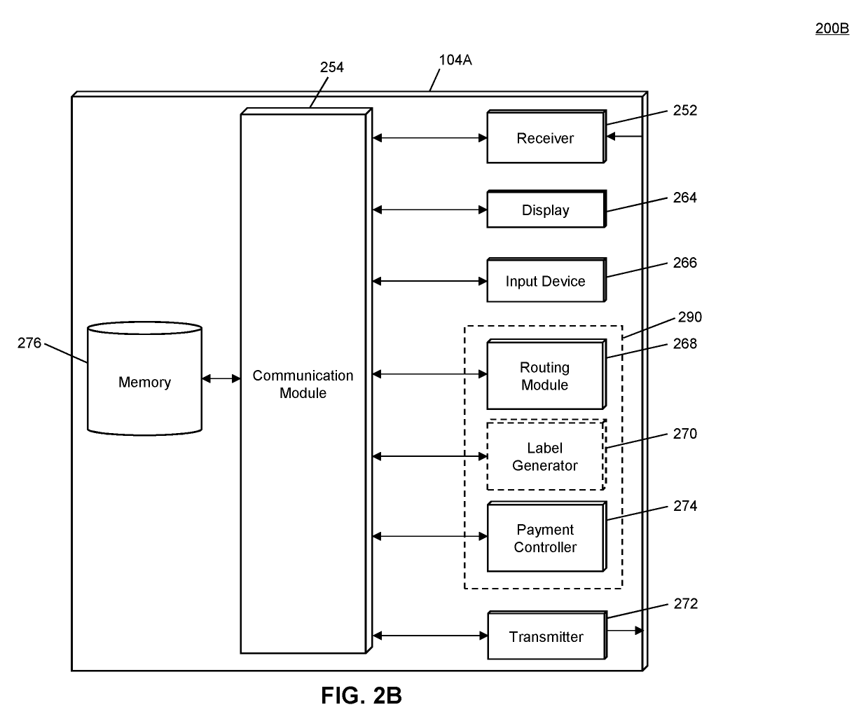

FIG. 1A depicts a system 100A with a processing server 102 configured to store parking information of one or more parking structures or areas. Although depicted as a single component, it is understood that multiple servers may be utilized to perform the functions of the described processing server 102. FIG. 2A depicts the components of the processing server 102. The processing server 102 includes a transmitter 222 and receiver 202 for communicating with other components of the system.

Parking information includes the geographic position for the parking spaces 150, 152, 154, 156, 158, 160 of each parking level 168 of the parking structure or area. The processing server 102 may also communicate with a parking controller 170 that collects information from an entrance 162 and an exit 164 of a parking level 168. Such information may be directly measured by sensors monitoring the entrance 162 and exit 164 of a level 168. Such information may also be measured from transactions at gates or other forms of ingress/egress control located at an entrance 162 or exit 164. The parking controller 170 may perform additional tasks associated with the parking level 168 such as controlling or monitoring the forms of ingress/egress (e.g., raising or lowering gates, counting the number of vehicles entering or exiting, opening or closing entrances 162 and exits 164, etc.).

The parking controller 170 may perform certain preliminary processing prior to transmitting information to the processing server 102. For example, a list of available parking spaces 150, 152, 154, 156, 158, 160 may be generated by parking controller 170 and transmitted to processing server 102 either periodically, by request, or upon any change in the list. Such list of available parking spaces 150, 152, 154, 156, 158, 160 may at least include identification information and an availability indicator of each available parking spaces, e.g., available, unavailable, reserved, etc. Although the depicted embodiment 100A includes a parking controller 170, such a controller 170 may not be required in the system contemplated herein as long as the needed information is communicated to the processing server 102 for consideration. Embodiments without a parking controller 170 may, for example, incorporate the same functionality in the processing server 102, or incorporate some of the same functionality in components such as the ingress/egress control components or sensors as well as the processing server 102.

The parking information of the one or more parking structures or areas are stored in the processing server 102. The parking information may include a list of available parking spaces in addition to other types of information to be associated with the parking structures or areas. The parking information may be arranged in any appropriate structure for storage and analysis, such as a relational database. Other data structures may be used as necessary and appropriate, but are not specifically articulated herein. In additional to the parking information representing the current state of the parking structures or areas, the processing server 102 can also reference historical parking information that may be stored locally in the processing server 102 or may be stored in another location so long as the information may be readily accessed. Other types of information may also be stored in the processing server 102 to facilitate the execution of the pricing model to be described below. Historical parking information may include space availability, average occupancy time, frequency of entrance and exit of vehicles, etc., for the parking structure or area for a plurality of different times. In some instances, historical parking information may be associated with additional conditions, such as weather conditions, nearby events, etc.

The processing server 102 monitors at least one parking structure or area by updating the parking information at predetermined internals or upon an event associated the parking structure or area. For example, the processing server 102 may receive information from the parking controller 170 regarding the parking structure or area, from user devices 104A operated by individuals with vehicles 104, or from other data sources, such as parking structure or area employees manually entering information or payment transactions. In some embodiments, the processing server 102 utilizes multiple data sources and aggregates the information in a manner to improve the representation of the current and historical states of the parking structure or area. In such an embodiment, the processing server 102 may receive information from a user device 104A and information from a payment transaction and associate the available information to confirm that a particular parking space was occupied by an individual's vehicle 104 by correlating the location of the user device 104A associated with the individual and vehicle 104, and the payment method associated with the individual. In addition, the pricing associated with the parking spot at a given date and time may also be stored for future analysis. Other types of information may also be considered, including information suitable for use in the pricing model described below.

FIG. 2A is a block diagram illustrating a processing server 102 of FIG. 1A for real time, geolocation based parking data analysis in accordance with exemplary embodiments. It will be apparent to persons having skill in the relevant art that the embodiment of the processing server 102 illustrated in FIG. 2A is provided as illustration only and may not be exhaustive to all possible configurations of the processing server 102 suitable for performing the functions as discussed herein.

Processing server 102 may include a processor 230. The processor 230 may be configured to perform the functions of processing server 102 discussed herein as will be apparent to persons having skill in the relevant art. In some embodiments, processing server 102, as shown in FIGS. 1A and 1B, may include a plurality of engines and/or modules specifically configured to perform one or more functions of processing server 102, such as a receiver 202, a vehicle detector 214, a parking fee calculator 216, a parking space detector 218, a transmitter 222, a communication module 204, an account database 206 including one or more account profiles 208, a transaction database 210 including one or more transaction data entries 212, a parking space database 240 including entries for each parking space, and a memory 224.

In an example embodiment, processor 230 may be configured to store parking information of one or more parking structures or areas in memory 224. As described above, the parking information may include geographic information of the parking structures or areas and geographic information for at least one parking space 150, 152, 154, 156, 158, 160 in each parking level 168 of the parking structure or area. A parking space detector 218 may be configured to identify one or more available parking spaces 150, 152, 154, 156, 158, 160 based on information obtained by sensors the parking structure or area such as the vehicle detector 214. Alternatively, the parking space detector 218 may rely on the parking controller 170 to determine if a given parking space 150, 152, 154, 156, 158, 160 is empty or occupied. The techniques for obtaining occupancy information may rely on components such as cameras, ultrasonic sensors, photoelectric sensors, pressure sensors, and other types of detection techniques may be used to determine occupancy of the parking space 150, 152, 154, 156, 158, 160. A list of available parking spaces 150, 152, 154, 156, 158, 160 may then be generated by parking controller 170. Alternatively, parking space detector 218, rather than parking controller 170, may generate the list of available parking spaces 150, 152, 154, 156, 158, 160. A list of available parking spaces 150, 152, 154, 156, 158, 160 is thus supplied to the processing server 102. Changes to the occupancy status of the parking spaces 150, 152, 154, 156, 158, 160 are detected using the same detection techniques and result in an updated list of available parking spaces 150, 152, 154, 156, 158, 160. This updated list may then be transmitted to the processing server 102 periodically, on request, or on change. The occupancy status of the parking spaces 150, 152, 154, 156, 158, 160 will be used as a consideration by the pricing model described below.

In some embodiments, the processing server 102 may perform additional analysis to estimate the relative occupancy of a parking structure or area and to provide additional information to the pricing module. FIG. 1B depicts an embodiment of the system 100B which includes an issuer server 106, acquirer server 110, and payment network 112. As shown, the processing server 102 of this embodiment communicates with the issuer server 106, acquirer server 110, and payment network 112. In this exemplary embodiment, the processing server 102 may consider information from each of these sources 106, 110, 112 when determining the appropriate price for a parking space in the parking structure or area. Such information, combined with actual occupancy information, is considered by the processing server 102 by way of inputs into the pricing model.

The processing server 102 may also consider the relative locations of certain vehicles 104 in the parking structure or area. The processing server 102 relies on the vehicle detector 214 to associate information with a particular vehicle 104. For example, the occupancy of a parking space 150, 152, 154, 156, 158, 160 may be confirmed by the parking spot detector 218 using ultrasonic techniques. A determination as to whether the proper vehicle is occupying the parking space 150, 152, 154, 156, 158, 160 is made by the vehicle detector 214 which utilizes, for example, the vehicle type, the license plate, the location of a user device 104A in the vicinity of the vehicle 104, and other techniques.

The processing server 102 uses the pricing model to determine the pricing for a particular parking space 150, 152, 154, 156, 158, 160. The prices may also be set to values that are predefined and not determined by the pricing model. In some examples, a parking fee for vehicle 104 may be calculated based on the time when the vehicle enters and leaves the parking structure or area. Alternatively, the parking fee for vehicle 104 may be calculated from the time when the user makes the reservation, rather than the time vehicle 104 enters parking structure or area. The parking fee calculator 216 utilizes the pricing model or the predefined pricing to determine a price for the parking space 150, 152, 154, 156, 158, 160.

The processing server 102 may receive selections of available parking spaces 150, 152, 154, 156, 158, 160 from individuals with user devices 104A. Upon receiving the selection of an available parking space by the individual, the processing server 102 may update the current list of available parking spaces. In other embodiments, the current list of available parking spaces is derived by other components of the system such as the parking controller 170 and the parking space detector 218. In certain embodiments, multiple types of information are utilized to provide a more accurate current list of available parking spaces.

In some embodiments, the processing server 102 may communicate with the acquirer server 110 on behalf of the individual to pay the parking fees. Other embodiments may delegate this responsibility to the user device 104A. Still other embodiments may rely on a payment method associated with a user account to pay the parking fees.

Parking space information may be organized and stored in a parking space database 240. Parking space information includes the geographic information regarding each parking space 150, 152, 154, 156, 158, 160, its occupancy status, and its location relative to other aspects of the parking level 168. Transaction data of different payment transactions may be organized and stored in transaction database 210 as transaction data entries 212. Transaction data entries 212 correspond to payment of parking fees initiated by a given individual. The transaction data entries 212 may be created by payments handled at least in part by the processing server 102. In other configurations, the transaction data entries 212 are derived from information provided by aspects of the payment network 112 such as historical transactions associated with an individual. Other sources may be used to confirm the validity of the transactions or to supplement the record of transactions. The transaction database 210 should not be considered as an authoritative ledger of transactions, but rather a collection of prior transactions that is considered as a data source for the pricing model described below. Information for a given individual may be stored in a corresponding account profile 208 in account database 206. Other information specific to the individual, such as the individual's demographics and preferences, are stored in the account profile 208. The account profile 208 may be considered by the pricing model described below.

### The User Device and the User Application

An individual associated with a vehicle 104 may operate on a user device 104A to select a parking structure or area near a destination. The user device 104A executes a user application that executes commands for the user device 104A to communicate with different aspects of the system described here. As shown in FIG. 2B, the user device 104A includes a variety of components including a processor, a memory 276, and a communication module 254 interconnecting other components such as a receiver 252, display 264, input device 266, processor 290, and transmitter 272. The processor 290 implements certain aspects such as a routing module 268, a label generator 270, and a payment controller 274. In some embodiments, user device 104A, as shown in FIGS. 1A and 1B, may include a plurality of engines and/or modules specifically configured to perform one or more functions of user device 104A, such as a receiver 252, a display 264, an input device 266, a routing module 268, a label generator 270, a payment controller 274, a transmitter 272, a communication module 254, and a memory 276.

The user device 104A is a device with sufficient processing and storage capabilities to perform the functions attributed to the user device 104A and the user application. The user device 104A also includes components for providing geographic information, such as a latitude or longitude. The user device 104A can also provide payment information by way of the payment controller 274 to satisfy the parking fees associated with parking spaces occupied by the individual. These and other aspects of the user device 104A are utilized by the user application to provide an easy to use interface for the individuals seeking parking.

In an example embodiment, receiver 252 may be configured to receive a list of available parking spaces and a geographic position associated with each of the available parking spaces from processing server 102. The list of available parking spaces may further include distances from each available parking space to other facilities such as elevators 166, entrances 162, and exits 164. Display 264 may be configured to display the available parking spaces to illustrate the geographic positions of the available parking spaces. For example, the available parking spaces may be displayed in a form of a map of a parking structure or area, and/or a map of the parking level 168. The available parking spaces may be shown in green to indicate the availability. The facilities such as elevators 166 and distances from each available parking space to the facilities may be displayed in the map as well. The user may then operate an input device 266, such as a keyboard or touch screen, to select one of the available parking spaces. Upon selection of the parking space, the routing module 268 may be configured to calculate one or more routes from the current position of vehicle 104 to the selected parking space. In some examples, user device 104A may determine a route to a selected parking structure or area using the routing module 268.

Depending on the particular implementation, the individual may select an individual parking space 150, 152, 154, 156, 158, 160 or select a reservation for a parking space 150, 152, 154, 156, 158, 160 to be determined upon arrival. Some implementations may allow the individual to preview the expected parking fee for a parking space 150, 152, 154, 156, 158, 160 in a particular parking structure or area. Other implementations may only allow the individual to preview the fee schedule associated with different parking durations. By previewing this pricing information along with the geographic location of the parking space, the individual can choose the price that fits their desires and expectations for a parking space, and secure the parking space prior to arriving at a particular parking structure or area.

The envisioned user application supports multiple modes of operation with different types of selection of a parking space 150, 152, 154, 156, 158, 160. In one scenario, the user device 104A is used to preselect a particular parking space 150, 152, 154, 156, 158, 160 prior to arrival at a parking structure or area. An interface is presented to the individual that receives the selection of a parking structure or area that is located near a desired location. This selection is transmitted to processing server 102, and upon receiving the selection, processing server 102 provides a list of available parking spaces 150, 152, 154, 156, 158, 160 for the selected parking structure or area to user device 104A. In addition to the list of available parking spaces 150, 152, 154, 156, 158, 160, processing server 102 may also provide a geographic position of each of the available parking spaces 150, 152, 154, 156, 158, 160 to user device 104A. Other types of information relevant to the desirability of the available parking spaces 150, 152, 154, 156, 158, 160 may also be provided such as proximity to elevators 166, stairs, or merchants. The prices for the parking spaces 150, 152, 154, 156, 158, 160 are also displayed. The price may be predetermined by the owner of the parking structure or area or the price may be calculated using the pricing model executed by the processing server 102 in the manner to be described below.

Another mode of operation allows the user to select a parking space 150, 152, 154, 156, 158, 160 in a manner similar to that described above. In contrast to the price for the parking space being displayed, this mode of operation provides the individual with the parking fee schedule associated with different periods of occupancy for the parking space. For example, the fees for the first hour of parking may be substantially lower than the fees associated with the second and third hours of parking. Each of the payment levels described by the parking fee schedule may be determined by the pricing model executed by the processing server 102 or be predefined by the parking structure or area.

Various visualizations of the parking space information are possible. The visualizations may be constructed at the processing server 102 or the user device 104A. In at least some examples, the processing server 102 may provide a map of the selected parking area 168. The maps of the parking area 168 may illustrate the availability of each parking space, unavailable or reserved parking spaces, and the locations of other relevant facilities of parking level 168, such as an elevator 166, entrance 162, and exit 164. With the visualization provided by the map, the relative distance between the available parking spaces and the facilities may be comprehended by the individual. The individual may then select one of the available parking spaces based on personal preferences. For example, if the individual plans to go shopping via elevator 166 after parking vehicle 104, the individual may select an available parking space closest to elevator 166. As shown in FIG. 1A, this would be parking space 156. In some other examples, the individual may select a level of the parking garage first and further select an available parking space on the level 168.

Whichever way the parking space information is presented, the individual selects the desired parking space causing the device 104A to transmit the selection to the processing server 102 so that the space is reserved for the individual associated with the user device 104A. In one such embodiment, specific directions to the selected parking space are then provided to the user by the processing server 102. In another embodiment, the individual drives to the desired parking structure or area and upon arrival, a parking space is assigned and directions to the selected parking space are provided. Some embodiments then immediately charge the payment method associated with the individual on the user device 104A. Certain embodiments may instruct the processing server 102 to charge a payment method associated with the user device 104A. Embodiments may also rely on payment methods associated with an account associated with the individual with the user device 104A. Other embodiments may charge the individual only upon departure from the parking structure or area.

The individual then travels in the vehicle 104 to the selected parking structure or area. The user device 104A may provide the route to the parking structure or area's entrance. Upon arrival at the parking structure or area, the user device 104A will provide guidance to the parking space assigned to the individual's vehicle 104. Embodiments of the system that assign the parking space may assign the parking space and transmit the information to the user device 104A upon arrival. The individual follows the instructions of the user device 104A to arrive at the assigned parking space and park the vehicle 104. The user device 104A may, in some embodiments, then transmit information to the processing server 102 that the vehicle 104 has parked in the assigned space. In other embodiments, the user device 104A receives input from the individuals or beacons and other signaling devices associated with the parking space that indicates the assigned space is occupied. Still other embodiments rely on sensing systems to detect the occupancy of the assigned parking space by a vehicle 104A.

Each of these embodiments also employ techniques to prevent the incorrect individuals from occupying an assigned space. For example, if the user device 104A is not associated with a particular parking space, the individual is alerted to their error. If, in another example, a different type of vehicle than what is assigned is parked in the parking space, the individual associated with the incorrect vehicle 104 is alerted to their error. Still further, if the license plate associated with the vehicle 104 parked in the space is not correct, the individual associated with the incorrect vehicle 104 is alerted to their error. Such detection of an improper individual may rely on the individual having, for example, an account profile 208 with details regarding their vehicle, vehicle type, and license plate. If the vehicle 104 is not parked in the correct space after the alert, a penalty fee may be charged to the individual. Other conventional forms of remediation, such as towing or ticketing, may also be used.

The envisioned user application may also provide other useful features. For example, the user application may provide the individual directions to the various facilities in the parking structure or area and to the vehicle 104. The user application may also provide reminders to the individual regarding the remaining time available for occupancy of the parking space. Some embodiments of the user application may allow the individual to authorize additional fees so that the vehicle 104 may remain in the parking space for an extended period of time. In certain embodiments, other services may be offered through the user application including tow services, car wash services, and taxi services for situations where the individual does not wish to drive their vehicle 104 home.

### The Pricing Model

In embodiments where the fee is calculated when the vehicle enters and leaves the parking structure or area, which may be determined when vehicle detector 214 detects that vehicle 104 is leaving the parking structure or area, parking fee calculator 218 may execute a pricing model to determine an amount of a parking fee for vehicle 104 in accordance with a pricing algorithm and one or more factors. The factors at least include a duration that vehicle stayed in parking structure or area or in parking space 150, 152, 154, 156, 158, 160. In some examples, the factors may further include the geographic position of parking space 150, 152, 154, 156, 158, 160, historic data of parking space 150, 152, 154, 156, 158, 160 in a relevant time frame, the time of a day when the selection of parking space 150, 152, 154, 156, 158, 160 is received, the number of individuals currently searching for a parking space, the number of individuals that intend to reserve a parking space among the plurality of parking spaces 150, 152, 154, 156, 158, 160, the number of available parking spaces 150, 152, 154, 156, 158, 160, the amount of time between receiving the indication of the selected parking space 150, 152, 154, 156, 158, 160 and the vehicle 104 entering the parking structure or area, and whether a payment was made prior to the vehicle 104 entering the parking structure or area. Other factors include the season, whether the current date is a holiday, the current and predicted weather, the scheduling of nearby events, and any discounts that may be associated with the individual. The historical data of the parking space 150, 152, 154, 156, 158, 160 may include prior values for these same factors among others. Other information may be incorporated into the pricing model to account for situations such as special events, holidays, and other events that affect the demand for parking spaces, as well as individual factors, such as a historical preference for a parking space near facilities, such as an elevator 168, or a historical preference for a parking space near a particular merchant or attraction.

By considering these and other factors, the pricing model makes a more accurate determination as to the proper pricing to offer to the individual. In some embodiments, where advance payment is made for a parking space 150, 152, 154, 156, 158, 160 for a predetermined period of time, the parking fee calculator executes a similar pricing model to determine the appropriate price for the parking space. The listed factors are simply exemplary items and should not be construed to be the entirety of the factors that may be considered in the described pricing model.

The historical data may be considered in a variety of ways including analysis for clustering and other time patterns, such as a spike of entrances from 6:00 am-9:00 am and a spike of exits from 5:00 pm-7:00 pm. Any clustering or time patterns observed may then be correlated with external factors, such as working hours and special events. The historical data may also include the conclusions reached by the pricing model so that comparisons between the predicted values and the actual values may be made. The pricing model considers the differences between the predicted values and actual values when making future pricing decisions. In some embodiments, the pricing model may make predictions using historical data to further refine the pricing model and to validate current models. In some embodiments, a neural network or machine learning system may be used to execute the pricing model and determine the optimal price.

The pricing model may consider also transaction information both current and historical. For example, the pricing model may detect a large number of transactions associated with parking services in a given area, and therefore adjust pricing accordingly to accommodate what appears to be high demand for parking spaces. The pricing model may also rely on historical transactions to determine the appropriate price. This is particularly useful for determining the duration an individual may stay in a particular parking space, and what prices might be deemed acceptable by individuals seeking a parking space in the area.

### Example Pricing Model Algorithm

One embodiment of the algorithm calculating the parking fee may be described as follows.

Parking fee=(αₜₛ+β1*T+β2*C+β3*A+β4*PT+β5*L+δ*TBR)*D

In this algorithm, aₜₛ is a base price of the parking space, which may be dynamically determined based on seasons and/or holidays. For example, the base price of a parking space in Washington, D.C. may be determined to be higher during periods, such as cherry blossom season and around Independence Day. T refers to the time of the day when the selection of the parking space is received. C refers to a count of users that simultaneously intend to reserve a parking space. A refers to a count of available parking spaces. PT refers to a time duration that the vehicle 104 stayed in the parking structure or area, or in the parking space. L refers to the geographic position of the parking space. TBR refers to the amount of time prior to the booking the reservation was made. D refers to any discount that may be applied to the parking fee. For example, prepaid parking fees may be cheaper than postpaid parking fees. β1, β2, β4, β5, and β6 refer to coefficient values learned continuously from data regarding payments for parking fees. Alternatively, β1, β2, β4, β5, and β6 may refer to weights that may be adjusted by an administrator of parking level 168 or parking structure or area.

### Example Usage of the System

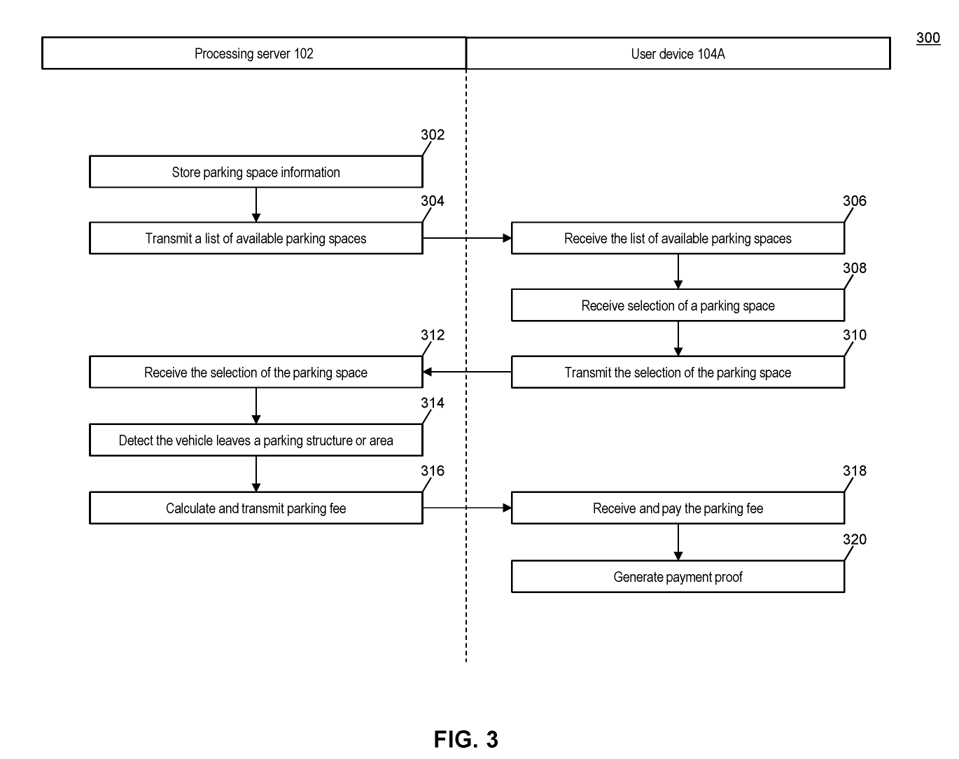

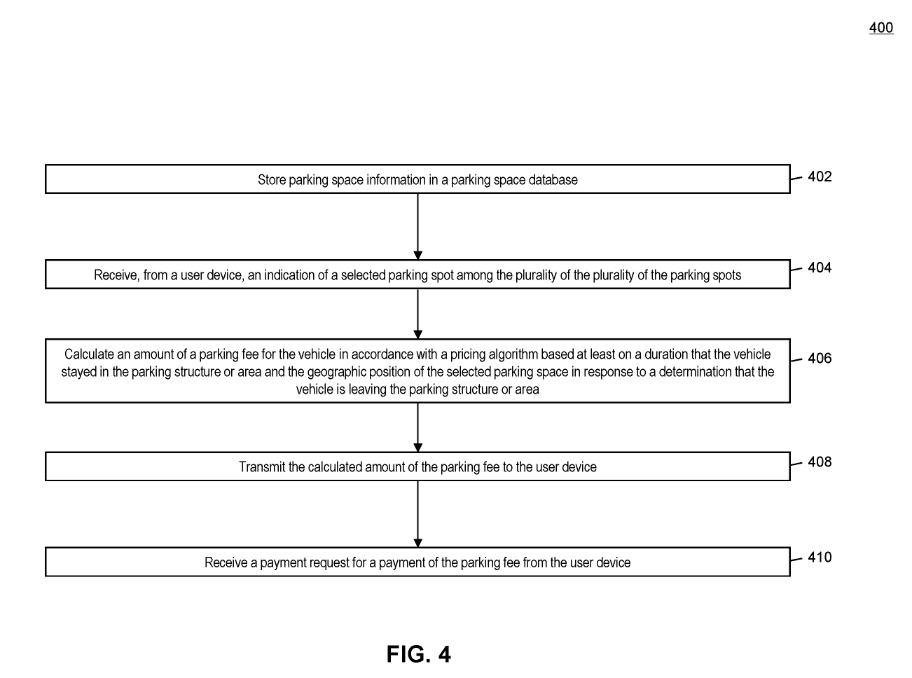

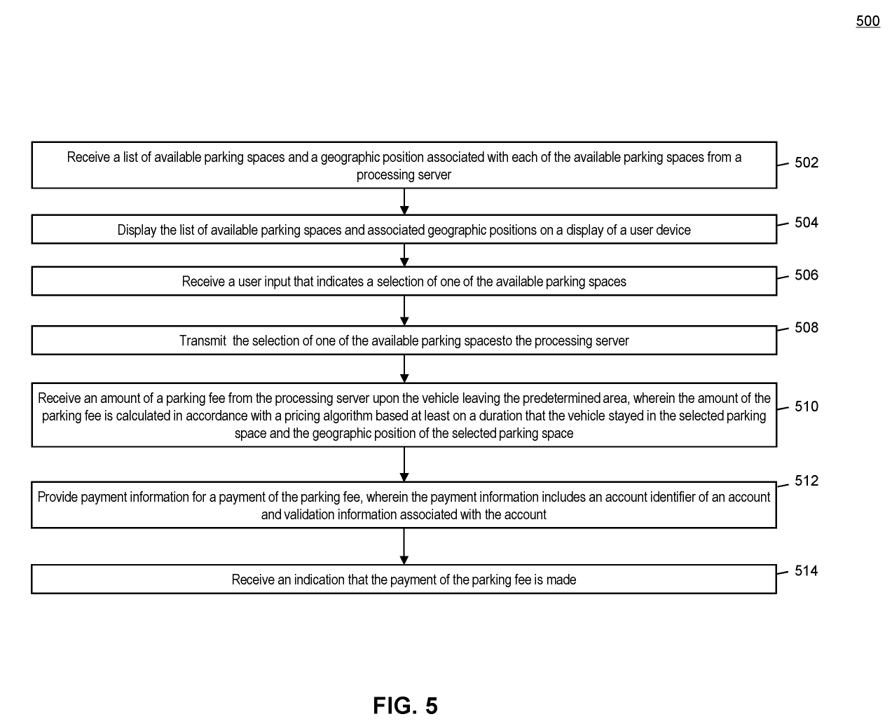

The system will now be described from the perspective of an individual with a user device 104A that seeks a parking space. The inquiring individual first identifies a parking structure or area in the vicinity of desired destination and queries a user device 104A as to the availability of parking spaces in the selected parking structure or area. The user device 104A utilizes the receiver 252 and the transmitter 272 to communicate with a processing server 102 through a communications network. As shown in FIGS. 3-5, the processing server 102 inquires as to the current availability of parking spaces 150, 152, 154, 156, 158, 160 associated with the selected parking structure or area and stores the parking space information in a parking space database 240 (steps 302, 402). The current availability of parking spaces 150, 152, 154, 156, 158, 160 considers spaces that are currently occupied and spaces with reservations. In some embodiments, the processing server 102 may also consider spaces that are likely to become available in the near future as part of the current availability of parking spaces 150, 152, 154, 156, 158, 160. For example, if a parking space was reserved for a period of time that is ending shortly, the processing server 102 may consider this parking space to be available for the currently inquiring individual. Other parking spaces whose availability may change prior to the inquiring individual's arrival may be considered as well so that the utilization of the parking structure or area is maximized. When generating the list of available parking spaces, the processing server 102 may tailor the weight assigned to each of these types of available or soon-to-be available spaces so that an accurate prediction as to the actual availability of parking spaces upon the individual's arrival is possible. The weights assigned to the spaces that will become available in the near future versus the spaces that are immediately available may be adjusted over time to improve the price obtained for each parking space and to improve the utilization of the parking structure or area.

Upon generation of the current list of available parking spaces, the processing server 102 may, in some embodiments, immediately generate a price for each available parking space 150, 152, 154, 156, 158, 160 for selection by the individual through the user device 104A. The price for each parking space 150, 152, 154, 156, 158, 160 may be derived from the pricing model or may be predetermined, depending on the parking structure or area. The price may be a flat-rate fee per hour or per visit. In some embodiments, the price may change depending on the period of occupancy in the parking space in accordance with a precalculated fee schedule. This precalculated fee schedule may include prices determined both by the pricing model and by predetermined values.

Other information is included with the list of available parking spaces including geographic information and relative location to facilities and/or merchants. When available, the list of available parking spaces may also include information describing the size of the parking space and any obstructions which may exist in the vicinity of the parking space. Once this information is collected, the processing server 102 transmits the list of available parking spaces 150, 152, 154, 156, 158, 160 to the user device 104A for consideration (step 304).

The user device 104A receives the list of available parking spots from the processing server 102 (steps 306, 502). The user device 104A will then utilize this information to display the available parking spaces 150, 152, 154, 156, 158, 160 for consideration by the individual (step 504). For example, the user device 104A may generate a map displaying the relative locations of the parking spaces 150, 152, 154, 156, 158, 160 on the parking level 168, along with any facilities such as elevators 166 that may exist at each parking level 168. When the parking structure or area includes multiple levels, a map for each parking level 166 may be generated for consideration. Some individuals may, however, prefer a quick way to determine the lowest cost parking space or the parking space closest to a particular location and so the list of available parking spots 150, 152, 154, 156, 158, 160 may be sorted in multiple ways to facilitate individual preferences of this kind. When the individual has found the desired parking space, the user device 104A receives a selection from the individual (steps 308, 506). This selection is then transmitted to the processing server 102 by way of the transmitter 272 of the user device 104A (step 310).

The processing server 102 receives the selection of the parking space from the user device 104A (step 312, 404). The processing server 102 then assigns the parking space's next availability to the individual with the user 104A. The individual then travels to the selected parking space and parks their vehicle 104 for a period of time. In some embodiments, aspects of the system, such as the parking controller 170 or the parking spot detector 218, determine if the proper vehicle has entered the parking structure or area, and/or the selected parking space. In other embodiments, the vehicle detector 214 may be used to confirm the proper vehicle 104 has entered the selected parking space. For example, the parking controller 170, the parking spot detector 218, and the vehicle detector 214 may receive information from an entrance gate indicating the vehicle 104 with the user device 104A has entered the parking structure or area, information from cameras in the parking structure or area that the vehicle 104 is on the appropriate parking level 168, and information from sensors at the parking space that the vehicle 104 has occupied the assigned parking space. Still other embodiments may utilize the location of the user device 104A in a parking structure or area, or the individual informing the user device 104A that the vehicle 104 is occupying the parking space to begin the time period when the parking space is occupied.

Once the individual has returned to the vehicle 104 and departed from the parking space, the processing server 102 receives information from components, such as the parking controller 170, the parking spot detector 218, and the vehicle detector 214, that indicate the parking space is no longer occupied (step 314). In some embodiments, the position of the user device 104A is used to determine if the parking space is occupied by the vehicle 104. Once the system concludes the vehicle 104 has departed from the parking space, the processing server 102 calculates the appropriate fee. In some embodiments, the previously agreed to fee associated with the parking space is charged to the individual by the processing server 102 (steps 316, 406, 408). In other embodiments, the parking fee is calculated based on the duration of time the vehicle 104 occupied the parking space and the agreed upon fee schedule. The processing server 102 performs these calculations and transmits the accrued parking fee to the user device 104A (steps 316, 406, 408).

The user device 104A receives the accrued parking fee from the processing server 102 (steps 318, 510). The individual reviews the parking fee and executes payment of the fee if the individual agrees the fee is correct (steps 318, 512). In some embodiments, the individual enters the information for payment. In other embodiments, the user device 104A includes the individual's payment information and the individual simply authorizes payment of the parking fee. In still other embodiments, the individual has an existing user account with payment information stored in the account database 206 of the processing server 102. In such an embodiment, the individual's account profile 208 is retrieved from the account database 206.

After the payment information is retrieved, this information is used to satisfy the parking fee. In some embodiments, the payment information is presented to the merchant 606 by way of the processing server 102, point of sale devices, and other devices configured to accept payment information 622. After receiving the payment information 622, the merchant 606 can include transaction details 624 with the payment information so that the charge may be made. The payment information and the transaction details are then included with a transaction data signal 626 for transmission to a gateway processor 608. In other embodiments, the payment information is included with transaction details provided by the merchant 606 for direct submission to a gateway processor 608.

The gateway processor 608 may be associated with a plurality of merchants 606 and a plurality of acquiring financial institutions 610. The gateway processor 608 receives the transaction details 624 and payment information 622 and forwards the appropriate information representing each transaction for each merchant 606 to the appropriate acquiring financial institution 610. The gateway processor 608 may also reformat the transaction data 628 to conform with the format required for a particular acquiring financial institution 610. The information is then transmitted 630 to the acquiring financial institution 610. An authorization request is then transmitted 634 to the transaction processing server 612. The transaction processing server 612 may perform value-added services for the payment transaction including fraud scoring, transaction or account controls, account number mapping, offer redemption, loyalty processing, and other similar services. The transaction processing server 612 may identify the issuing financial institution 602 which is the financial institution with which the individual has an existing relationship. For example, the issuing financial institution 602 may be a bank, credit union, or another financial services provider. The issuing financial institution 602 then authorizes the transaction amount for payment of the parking fee 640. This authorization response 642 is then transmitted to the transaction processing server 612. The transaction processing server 612 may then perform further value-added services 636 prior to forwarding the authorization response 644 to the acquiring financial institution 610. The acquiring financial institution 610 then takes the authorization response 644 and generates a response message 646 for transmission to the gateway processor 608. The gateway processor 608 then transmits a response message 648 to the merchant 606 that provides proof of payment. The merchant 606 may then forward this proof of payment to the user device 104A of the individual. In some embodiments, the gateway processor 608 directly transmits the response message 648 to the user device 104A of the individual because the merchant 606 was not directly involved in the transaction.

Through the above described interaction with the payment network 112, a charge to the individual's account is made to satisfy the parking fee (step 512). Some embodiments of the system may involve the user device 104A contacting the parking structure or area's gateway processor 608 or acquiring financial institution 610 for payment processing. In other embodiments, the user device 104A transmits the payment information so that the processing server 102 can contact the appropriate acquirer for payment processing (step 410). Still other techniques of interfacing with the desired payment network 112 for satisfying the parking fee are possible but not specifically described here. Some embodiments of the system may allow for the individual to place a charge for the incurred parking fee on their account profile 208 stored by the processing server 102. Through any of these techniques, a transaction is recorded that provides information as to the time and location of the parking space occupied, and the parking fee incurred.

Once the payment is complete and confirmed by the payment network 112, the user device 104A receives an indication that the parking fee has been paid or otherwise satisfied (step 514). This indication may be the response message 648 transmitted by the gateway processor 608, for example. In other embodiments, this indication may be a separate notification transmitted by the merchant 606. After receiving this indication, in some embodiments the user device 104A may generate a unique label using the label generator 270. The unique label is generated as a form of easily readable payment confirmation that can be scanned and processed by, for example, the exit gate at the exit 164 of the parking level 168 or of the parking structure or area (step 320).

After completion of payment, the processing server 102 may execute the pricing model to evaluate whether the price paid for the parking space was optimal. The processing server 102 may also consider payment transactions for parking spaces similar to the recently paid for parking space to determine whether the price paid for the parking space was optimal. These payment transactions need not be for parking spaces within the same parking structure or area, however. Instead, the payment transactions can be for prices paid in comparable nearby parking spaces that are traditionally managed with a fixed parking rate, for example. The processing server 102 may also compare the results from different pricing strategies implemented in the same parking structure or area. For example, the processing server 102 may compare the revenue earned for the parking spaces closest to the elevator 166 versus the revenue earned for the parking spaces closest to a major retailer. The results of this analysis are incorporated into the pricing model so that future generated prices better utilize the available parking spaces at the parking structure or area.

With the described system for real time pricing for parking spaces, owners of parking structures or areas will be able to realize additional revenue due to the use of an optimizing pricing strategy. Additionally, individuals seeking parking near a destination will be able to easily find a parking space that is acceptably priced and appropriately located. In addition, the individuals need not spend time seeking the desired parking space, nor will the individuals need to remember the precise location of their parked vehicle 104.

Techniques consistent with the present disclosure provide, among other features, systems and methods for generating and using indexing models for real time pricing for parking spaces. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing real time pricing for parking space, comprising:
storing parking space information in a parking space database, wherein the parking space information includes a plurality of parking space identifiers corresponding to a plurality of parking spaces and a geographic position of each of the plurality of parking spaces;
receiving, from a user device, an indication of a selected parking space among the plurality of the parking spaces;
calculating an amount of a parking fee for a vehicle associated with the user device in accordance with a pricing algorithm based at least on a duration that the vehicle stayed in a predetermined area that encompasses the selected parking space and the geographic position of the selected parking space in response to a determination that the vehicle is leaving the predetermined area;
transmitting the calculated amount of the parking fee to the user device; and
receiving a payment request for a payment of the parking fee from the user device.

2. The method of claim 1, wherein the parking space information further includes a distance from each of the plurality of parking spaces to a predetermined location.

3. The method of claim 1, further comprising identifying one or more available parking spaces from the plurality of parking spaces.

4. The method of claim 3, wherein the one or more available parking spaces are identified based at least on images captured by one or more cameras detecting whether given parking spaces are empty or occupied.

5. The method of claim 1, wherein the amount of the parking fee is calculated further based on at least one of:
historic data of the plurality of parking spaces in a relevant time frame,
time of a day when the selection of the parking space is received,
a count of users that intend to reserve a parking space among the plurality of parking spaces,
a count of available parking spaces,
an amount of time between receiving the indication of the selected parking space and the vehicle entering the predetermined area, and
a determination whether a payment is made prior to the vehicle entering the predetermined area.

6. The method of claim 1, wherein the determination that the vehicle is leaving the predetermined area is made based on images captured by one or more cameras.

7. The method of claim 1, wherein the determination that the vehicle is leaving the predetermined area is made based on a signal transmitted from the user device.

8. The method of claim 1, further comprising transmitting, to an exit controller, an indication that the payment of the parking fee has been made.

9. The method of claim 8, wherein the indication that the payment of the parking fee has been made includes a machine readable label.

10. A method for reserving parking space, comprising:
receiving a list of available parking spaces and a geographic position associated with each of the available parking spaces from a processing server;
displaying the list of available parking spaces and associated geographic positions on a display of a user device;
receiving a user input that indicates a selection of one of the available parking spaces;
transmitting the selection of one of the available parking spaces to the processing server;
receiving an amount of a parking fee from the processing server upon a vehicle leaving a predetermined area that encompasses the available parking spaces, wherein the amount of the parking fee is calculated in accordance with a pricing algorithm based at least on a duration that the vehicle stayed in the predetermined area and the geographic position of the selected parking space;
providing payment information for a payment of the parking fee, wherein the payment information includes an account identifier of an account and validation information associated with the account; and
receiving an indication that the payment of the parking fee is made.

11. The method of claim 10, further comprising
receiving coordinates of the geographic position of the selected parking space; and
calculating a route from a location of the user device to the geographic position of the selected parking space.

12. The method of claim 10, further comprising receiving a distance from the selected parking space to a predetermined location.

13. The method of claim 10, wherein the amount of the parking fee is calculated further based on at least one of:
historic data of the plurality of parking spaces,
time of a day when the selection of the parking space is received,
a count of users that intend to reserve parking spaces,
a count of the available parking spaces,
an amount of time between receiving the indication of the selected parking space and the vehicle entering the predetermined area, and
a determination whether a payment is made prior to the vehicle entering the predetermined area.

14. The method of claim 10, further comprising transmitting a notification of leaving the selected parking space.

15. The method of claim 10, further comprising displaying a difference between a base price of the selected parking space and an average base price of the available parking spaces.

16. The method of claim 10, further comprising associated a payment card number with future payments of parking fees prior to receiving the list of available parking spaces.

17. A system for providing real time pricing for parking space, comprising:
a storage unit configured to store parking space information in a parking space database, wherein the parking space information includes a plurality of parking space identifiers corresponding to a plurality of parking spaces and a geographic position of each of the plurality of parking spaces;
a receiver configured to receive, from a user device, an indication of a selected parking space among the plurality of the plurality of the parking spaces;
a parking fee calculator configured to calculate an amount of a parking fee for a vehicle associated with the user device in accordance with a pricing algorithm based at least on a duration that the vehicle stayed in a predetermined area that encompasses the selected parking space and the geographic position of the selected parking space in response to a determination that the vehicle is leaving the predetermined area; and
a transmitter configured to transmit the calculated amount of the parking fee to the user device.

18. The system of claim 17, wherein the parking space information further includes a distance from each of the plurality of parking spaces to a predetermined location.

19. The system of claim 17, wherein the receiver is further configured to receive a payment of the parking fee from the user device.

20. The system of claim 17, further comprising a parking space detector configured to identify one or more available parking spaces from the plurality of parking spaces.

21. The system of claim 20, wherein the parking space detector is configured to identify the one or more available parking spaces based at least on images captured by one or more cameras detecting whether given parking spaces are empty or occupied.

22. The system of claim 17, wherein the amount of the parking fee is calculated further based on at least one of:
historic data of the plurality of parking spaces in a relevant time frame,
time of a day when the selection of the parking space is received,
a count of users that intend to reserve a parking space among the plurality of parking spaces,
a count of available parking spaces,
an amount of time between receiving the indication of the selected parking space and the vehicle entering the predetermined area, and
a determination whether a payment is made prior to the vehicle entering the predetermined area.

23. The system of claim 17, wherein the determination that the vehicle is leaving the predetermined area is made based on images captured by one or more cameras.

24. The system of claim 17, wherein the transmitter is further configured to transmit, to an exit controller, an indication that the payment of the parking fee has been made.

25. A system for reserving parking space, comprising:
a receiver configured to receive a list of available parking spaces and a geographic position associated with each of the available parking spaces from a processing server;
a display configured to display the list of available parking spaces and associated geographic positions on a display of a user device, wherein the receiver is further configured to receive a user input that indicates a selection of one of the available parking spaces;
a transmitter configured to transmit the selection of one of the available parking spaces to the processing server, wherein the receiver is further configured to receive an amount of a parking fee from the processing server upon a vehicle leaving a predetermined area that encompasses the available parking spaces, wherein the amount of the parking fee is calculated in accordance with a pricing algorithm based at least on a duration that the vehicle stayed in the predetermined area and the geographic position of the selected parking space; and
a payment controller configured to provide payment information for a payment of the parking fee, wherein the payment information includes an account identifier of an account and validation information associated with the account, wherein the receiver is further configured to receive an indication that the payment of the parking fee is made.

26. The system of claim 25, further comprising a routing module configured to calculate a route from a location of the user device to the geographic position of the selected parking space based on coordinates of the geographic position of the selected parking space.

27. The system of claim 25, wherein the receiver is further configured to receive a distance from the selected parking space to a predetermined location.

28. The system of claim 25, wherein the amount of the parking fee is calculated further based on at least one of:
historic data of the plurality of parking spaces,
time of a day when the selection of the parking space is received,
a count of users that intend to reserve parking spaces,
a count of the available parking spaces,
an amount of time between receiving the indication of the selected parking space and the vehicle entering the predetermined area, and
a determination whether a payment is made prior to the vehicle entering the predetermined area.
